(19) United States
(12) Patent Application Publication
(10) Pub. No.: US 2024/0036571 A1
(43) Pub. Date: Feb. 1, 2024

(54) TELEOPERATIONS QUEUEING FOR AUTONOMOUS VEHICLES

(71) Applicant: Zoox, Inc., Foster City, CA (US)

(72) Inventors: Meredith James Goldman, Redwood City, CA (US); Rachel Gelb, New York, NY (US); Ravi Gogna, San Jose, CA (US); Alexander Jacques Maria Mertens, San Francisco, CA (US); Paul Orecchio, Denver, CO (US)

(21) Appl. No.: 17/876,975

(22) Filed: Jul. 29, 2022

(51) Int. Cl. G05D 1/00; G06Q 10/06

(52) U.S. Cl. CPC G05D 1/0027; G05D 1/0038; G06Q 10/063114; G06Q 10/063112; G05D 2201/0213

(57) ABSTRACT

A remote operations system receives a request for remote operator assistance and adds the request to a queue of additional requests. The queue may be ordered based on time of receipt, priority, criticality, and the like. The remote operations system determines a remote operator of a set of remote operators to provide a response to the request in the queue based at least in part on one or more of a status of the remote operator (e.g., indicative of availability, whether they are in training, etc.), criteria associated with the remote operator (e.g., skills in responding to various requests, preferences for a geographic area, mission types, etc.), and information associated with the request received from the vehicle (e.g., mission type, sensor data, messages, vehicle status, etc.). If the request is not accepted in a threshold period of time, the request may be rerouted to an additional remote operator.

### BACKGROUND

Semi- and fully-autonomous vehicles introduce a new set of technical challenges relative to driver-operated vehicles. For example, an autonomous vehicle may encounter a scenario that has not previously been encountered or that is complex enough that the autonomous vehicle cannot determine with a sufficient level of certainty how to traverse the scenario. In such situations, inputs from remote operators may assist the autonomous vehicle to traverse the scenario.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIG. 1 is a schematic scenario of an example environment through which an example vehicle travels along a road, and a remote operation system configured to provide assistance to the vehicle, according to at least some examples.

FIG. 2 is a block diagram including an example vehicle system architecture and remote operation system, according to at least some examples.

FIG. 3 is a block diagram of an example remote operation system architecture, according to at least some examples.

FIG. 4 is a block diagram of an example process for selecting remote operator(s) to provide assistance to a vehicle, according to at least some examples.

FIG. 5 is a block diagram of an example process for selecting remote operator(s) to provide assistance to a vehicle, according to at least some examples.

### DETAILED DESCRIPTION

This application relates to techniques for matching remote operators with autonomous vehicles that have requested assistance for traversing an environment. In some examples, the autonomous vehicle may periodically transmit information associated with a status of the autonomous vehicle, such as a current mission of the vehicle, a location of the vehicle, pose of the vehicle, speed, directionality, and so forth to a remote operator system. Such information is useful in determining a remote operator(s) to assist the vehicle, for example, if the autonomous vehicle requests assistance to traverse the environment. In some examples, the remote operator(s) may be associated with (or otherwise provide) criteria associated with the types of assistance they provide or wish to provide. Additionally, an availability of the remote operator, such as whether they are online to provide assistance, and/or whether they are occupied, is helpful in assigning the requests to the remote operators. The remote operator(s) are optimally matched with autonomous vehicles requesting assistance as a way to quickly resolve incidents without noticeable delay.

The autonomous vehicle may be in communication with a remote operation system that receives the information associated with the status of the autonomous vehicle. In some examples, the autonomous vehicles are configured to automatically transmit the information according to predetermined schedules (e.g., every second, every minute, etc.) and/or upon the occurrence of certain events (e.g., upon request of a fleet monitoring service, upon the vehicle traveling a threshold distance, upon detection of an object, upon an inability to traverse a region, a level of uncertainty falling to or below a threshold level, passenger issues, etc.). The information informs the remote operation system of the state of the autonomous vehicles, may indicate any number of indicators including, but not limited to, whether the autonomous vehicle is in need of assistance, a type of assistance sought, provides information regarding the vehicle's surroundings, and so forth. As noted above, such information sent by the autonomous vehicle may include a current state of vehicle, such as speed, orientation (or heading), location, whether a remote operator is communicating with and/or controlling the autonomous vehicle, a health status of components of the autonomous vehicle (e.g., brakes, microcontrollers, HVAC controllers, etc.), mission type (e.g., recharging, training, hauling passengers, picking up passengers, etc.), and so forth. The remote operation system may communicate with and monitor the status of any number of autonomous vehicles within a fleet.

The remote operation system is associated with one or more remote operators that respond to or otherwise provide assistance to the autonomous vehicles. In some examples, the remote operators are able to set criteria associated with the assistance that they provide to the remote vehicles. For example, the remote operators may be associated with criteria including, for example, a vehicle type, location, type of assistance, mission-type, and so forth. As a non-limiting example, one operator may be associated with criteria related to responding to issues regarding the internal components (e.g., HVAC, brakes, communications systems, etc.), another may have criteria indicating skills with respect to situational awareness and planning, while another may be associated with criteria regarding passenger issues (e.g., medical emergencies and the like).

Additionally, or alternatively, the remote operators may be able to set their status. The status may generally indicate an availability of the remote operators, such as whether the remote operator is on break, in training mode (e.g., and unable to accept all or certain types of requests), whether the remote operator is already providing assistance to another request, whether the remote operator is accepting requests, and so forth. More generally, the status indicates whether the remote operator is occupied or unoccupied for purposes of receiving requests and providing assistance to the vehicles. As discussed herein, the criteria and/or the status are used to match the remote operators with vehicles requesting assistance.

The remote operation system further has insight into those remote operators that are available. For example, certain remote operators may be on-duty or off-duty. Those remote operators that are on-duty may be available, while those remote operators that are off-duty may be unavailable. Using those remote operators that are available, the remote operation system may filter the remote operators when assigning the requests. In some examples, the remote operation system may determine those remote operators that are available based on the remote operators being logged into the remote operation system, and/or the remote operators providing an indication thereof (e.g., the remote operators may switch their status to available).

In some examples, from time to time, the autonomous vehicle may encounter an event that it is unable to confidently traverse, such as an event that is unpredictable in nature, poses safety concerns, is of a type that has not previously been encountered, or requires responses to spontaneous visual cues or direction from, for example, police officers or construction workers. Of course, such examples are provided for illustrative purposes only and are not meant to be so limiting. In some examples, the autonomous vehicle may be unable to plan a path to traverse an obstacle and/or may determine that a confidence level associated with one or more maneuvers (e.g., a planned trajectory or path of the autonomous vehicle) and/or events (e.g., detection or classification of a particular object, prediction of a behavior of an object, etc.) is insufficient (e.g., is below a threshold confidence level) to proceed autonomously. In such cases, the autonomous vehicle may send a request to the remote operation system to obtain guidance. In some examples, a passenger may initiate such a request such as, for example, by hitting a button, speaking a phrase, or by being recognized by vehicle systems as requiring assistance (e.g., using internal cameras and/or microphones).

The remote operator may provide assistance to the autonomous vehicle and/or passengers within the autonomous vehicle, in any suitable manner. In some examples, the assistance may include transmitting processor-executable instructions via a network interface from the device of the remote operator to the autonomous vehicle. These instructions may cause the autonomous vehicle to perform an operation, to collaborate with the autonomous vehicle to determine an operation to perform, and/or to confirm a potential operation that the autonomous vehicle has determined. In various examples, such instructions may also comprise audiovisual messages to display to the one or more passengers.

The remote operation system may receive the requests from the plurality of autonomous vehicles. As the requests are received, the requests may be ordered within a queue and conveyed to the remote operator(s) for processing. In some examples, the requests may be ordered within the queue based on a time at which the request was received. Additionally, or alternatively, the requests may be prioritized based on certain safety considerations, such as a vehicle operating speed (e.g., highway operation versus city street operation), occupancy status of the vehicle (occupied or vacant, number of occupants, etc.), length of ride, traffic volume, or other factors. Regardless, upon receipt of the requests, the remote operation system may select remote operators for responding to the requests.

In some examples, the requests and the remote operators may be matched based on the vehicle information, details of the request, the status of the remote operators, and/or criteria of the remote operators. Initially, those remote operators that are available may be filtered from a plurality of remote operators associated with the remote operations system. Of those remote operators that are available, the status and/or the criteria of the remote operators may be used as a way to filter the requests and select available remote operators for responding to the requests. Selecting the remote operators in this manner may increase response time and provide effective assistance. For example, if a remote operator requests to provide assistance within a particular geographical region (e.g., area), that remote operator may be knowledgeable and/or informed of how to navigate within the particular geographic region. Upon a request being received that is associated with an autonomous vehicle within the particular geographic region needing assistance, the remote operator may be selected (potentially over one or more other remote operators) to provide assistance. This may allow the remote operator to quickly understand the situation and respond accordingly, as compared to if the remote operator is unfamiliar with the geographic region, which may result in delays in guiding the autonomous vehicle. In at least some such examples, knowledge of a particular geographic area may be acquired based on relative a number of requests that the remote operator has responded to with respect to the area.

Further, in some examples, mission-type may be used to filter requests. For example, an autonomous vehicle may be operating in training mode by driving around test facilities. If such autonomous vehicle issues a request for assistance, this request may be ignored, placed in a separate queue, or otherwise treated differently than vehicles that are not operating in the training mode. As an additional example, if a remote operator is being trained about how to provide assistance to the autonomous vehicles, the remote operator may be filtered out as being unable to respond to the requests (or certain types of requests). This may ensure a safety of the autonomous vehicles and a quality of assistance provided. In some examples, any number of filters may be applied to match the remote operators to the requests, and the order in which the filters are applied may be dynamic depending on the circumstances. In some examples, the order in which the filters are applied may be hierarchical based on relative priorities of the various filters applied.

Upon determining a remote operator for a particular request, the remote operation system may send the request to the remote operator. In some examples, this includes displaying an indication of the request on a device operated by the remote operator. The remote operator may have a predetermined amount of time to respond to (e.g., accept) the request. If a response is received within the predetermined amount of time, the request is assigned to the remote operator. Alternatively, if the response is not received within the predetermined amount of time, the request may be sent one or more additional remote operators and/or placed back into a queue for reassignment. In some examples, a first of the remote operators to respond, and accept, the request may be assigned the request in order to provide assistance to the autonomous vehicle.

In response to the request being assigned to a remote operator, the device of the remote operator may display information associated with the autonomous vehicle. Such information may include, for example, sensor data generated by the autonomous vehicle (e.g., image data, lidar data, etc.) and/or a graphical representation of the sensor data (e.g., a synthetic, computer generated scene based on the sensor data). This allows the remote operator to be aware of a situation of the autonomous vehicle so that the remote operator may provide guidance to the autonomous vehicle with minimum delay. Of course, any other data sent from the vehicle is contemplated to be shown or otherwise relayed to the remote operator including, for example, internal camera data, microphone data, vehicle state, etc.

In some examples, if more than two remote operators match a request, the remote operation system may select the remote operator in order to load balance requests between the two remote operators. For example, if a first remote operator and a second remote operator are capable of providing assistance to the request, the remote operation system may select the remote operator that has responded to the least amount of requests over a given period (e.g., shift, hour, day, etc.), the remote operator that has the quickest historical response time (based on all historical responses times, recent response times, etc.), the remote operator that has the most restrictions (i.e., the remote operator that on average is likely to match fewer requests), or the remote operation system may randomly select from among the remote operators matching the request. In at least some examples, the remote operator associated with a previously successful resolution to a similar request may be selected and/or the remote operator with the greatest percentage of successful resolutions of requests. Additionally, or alternatively, if more than two remote operators match a request, the remote operation system may select the remote operator based on experience, a type of request associated with the vehicle (e.g., construction), an amount of time since the remote operator last responded to a request, a familiarity of the remote operator with the geographical area of the vehicle, a latency associated with the terminal associated with the teleoperator, and so forth.

The techniques and systems described herein may be implemented in a number of ways. Example implementations are provided below with reference to the figures. The implementations, examples, and illustrations described herein may be combined.

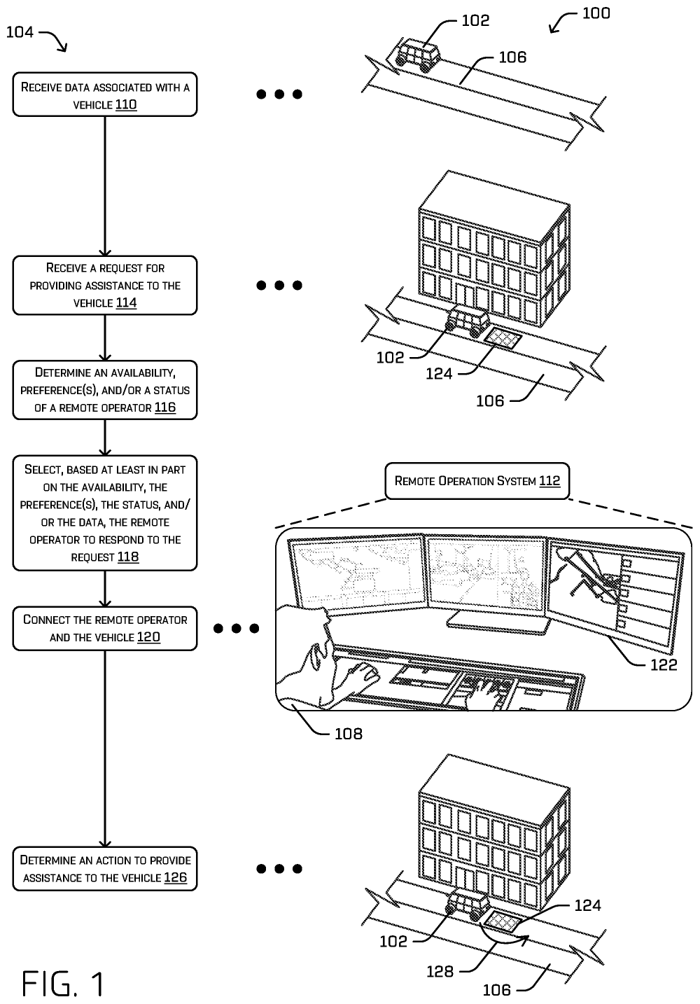

FIG. 1 is a schematic diagram of an environment 100 through which a vehicle 102 travels. The vehicle 102 may be an autonomous vehicle, such as an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle 102 at any time. In some examples, since the vehicle 102 may be configured to control all functions from start to route completion, including all parking functions, the vehicle 102 may not include a driver and/or implements for controlling the vehicle 102 such as a steering wheel, etc. In some examples, the techniques described herein may be incorporated into any ground-borne, airborne, or waterborne vehicle (or autonomous vehicle), including those ranging from vehicles that need to be manually controlled by a driver at all times, to those that are partially or fully autonomously controlled. In some examples, the vehicle 102 may represent an autonomous vehicle that is part of a fleet of autonomous vehicles.

In FIG. 1, an example scenario 104 is illustrated in which the vehicle 102 may operate autonomously until the vehicle 102 encounters an event (e.g., a set of conditions internal or external to the vehicle 102 including environment and operating conditions of the vehicle 102) along a road 106 for which the vehicle 102 may request assistance from, for example, a remote operator 108 located remotely from the vehicle 102. For example, at 110, the vehicle 102 may be traveling along the road 106 in normal fashion. As part of this, the vehicle 102 may continuously transmit operational state data associated with the vehicle 102, though such transmissions need not be continuous and may be sent upon the occurrence of an event or at some interval. The operational state data may include, without limitation, a current state of the vehicle 102 such as speed, heading, location, whether a remote operator is connected to/controlling the vehicle 102, mission-type (e.g., carrying passengers, picking up passengers, recharging batteries of the vehicle, test-mode), and so forth.

At 114, the vehicle 102 may encounter a construction zone 124 associated with a portion of the road 106, and traffic in the vicinity of the construction zone 124 may be under the direction of a construction worker who provides instructions for traffic to maneuver around the construction zone 124. Due in part to the unpredictable nature of this type of event, the vehicle 102 may request remote assistance from a remote operation system 112. The remote operation system 112 therefore receives, at 114, a request for remote assistance to guide the vehicle 102.

As will be explained herein, the remote operation system 112 includes a request queue (as may be managed by one or more remote servers) and remote operators (e.g., such as the remote operator 108). The request queue serves to organize requests in response to the vehicle 102, as well as other vehicles, asking for assistance. In some examples, the requests are organized and ordered in the request queue based on a time at which the requests are received, a priority, a geographic location, and the like or any combination thereof. The request queue is used by the remote operation system 112 to organize the requests and assign the requests to the remote operators. Of course, multiple request queues may be implemented simultaneously with an individual queue having differing criteria for ordering inbound requests and different sets of operators to service those requests.

As part of assigning the request to the remote operators 108, the remote operation system 112 may determine an availability, preference(s), and/or a status of the remote operators 108 at 116. For example, the availability of the remote operators 108, such as whether they are on-duty or off-duty, may be used to filter those remote operators that are connected to the remote operations system 112 and able to provide assistance. The status may further indicate, of those remote operators that are available, whether individual remote operators are on break, in training mode (and unable to provide assistance), whether the remote operators are already providing assistance to a vehicle, and so forth. Here, the status may therefore indicate whether the remote operators are occupied or unoccupied for purposes of providing assistance to the vehicle 102. The preference(s) may be set by the remote operators 108 and correspond to the types of assistance, or instances of assistance, in which the remote operators 108 wish to provide. For example, remote operators 108 may desire to only assist vehicles within a certain geographical region, on certain mission types, vehicles of a certain type, vehicles needing a predetermined assistance (e.g., maneuvering around construction zone, accident, etc.), and so forth. In such instances, the remote operators 108 have the ability to customize the type of incidents that they respond to, or provide assistance to.

After determining the preference(s) and/or the status, at 118, the scenario 104 may select the remote operator to respond to the request. For example, the remote operation system 112 may match the request to the operator based on the availability, the preference(s), and/or the status. Furthermore, such matching may be based on the operational state data received from the vehicle 102. For example, the operational state data may indicate a location of the vehicle, which is compared against a geographical location in which the remote operator 108 wishes to provide assistance. As discussed herein, the remote operator 108 that is selected may be from among a plurality of remote operators of the remote operation system 112, where each remote operators may have their own preference(s) and status.

At 120, the remote operator 108 may be connected to the vehicle 102. For example, the remote operator 108 may interact with the vehicle 102 via a user interface that can include a remote operator interface. The remote operator interface may include one or more displays 122 configured to provide the remote operator 108 with data related to an operation of the vehicle 102, a subset of the fleet of vehicles, and/or the fleet of vehicles. For example, the displays 122 may be configured to show data related to sensor signals received from the vehicle 102, data related to the road 106, and/or additional data or information to facilitate providing assistance to the vehicle 102. In some examples, the remote operator 108 may first be provided with an opportunity to accept or deny the request, and based at least in part on the response of the remote operator 108, the remote operator 108 may or may not be connected to the vehicle 102. For example, an indication may be displayed on one or more of the displays 122 that allows the remote operator 108 to accept or deny the request. Additional examples of connecting a remote operator or remotely controlling a vehicle are described in, for example, U.S. Pat. No. 11,209,822, entitled “Techniques for Contacting a Teleoperator,” the entirety of which is herein incorporated by reference for all purposes.

The remote operator 108 may utilize one or more devices associated with the displays 122, for example, that allow the remote operator 108 to provide information to the vehicle 102. Such information may be in the form of remote operation signals providing guidance to the vehicle 102. The remote operator device may include one or more of a touch-sensitive screen, a stylus, a mouse, a dial, a keypad, a microphone, a touchscreen, and/or a gesture-input system. In some examples, the remote operators 108, which may be human remote operators, may be located at a remote operations center. However, in some examples, one or more of the remote operators 108 may not be human, such as, for example, they may be computer systems leveraging artificial intelligence, machine learning, and/or other decision-making strategies and, in at least some examples, having different or more powerful computational resources or algorithms than available on the vehicle.

The remote operator 108 may provide assistance to the vehicle 102. For example, at 126, the remote operator 108 may determine an action 128 that provides assistance to the vehicle 102, such as maneuvering around the construction zone 124. In some examples, the remote operator 108 may provide the vehicle 102 with guidance to avoid, maneuver around, or pass through events. Additionally, or alternatively, the remote operator 108 may communicate with passengers of the vehicle 102, for example, using a microphone, a speaker, and/or a haptic feedback device.

Although FIG. 1 and the scenario 104 depicts a single instance of providing assistance to the vehicle 102, or providing assistance to a single vehicle, the remote operation system 112 may receive any number of requests from vehicles. For example, the vehicle 102 may be part of a fleet of vehicles in communication with the remote operation system 112, and the remote operation system 112 is configured to handle the requests and assign the request to respective remote operators 108.

In such examples, the vehicle 102 may encounter different events that result in a request for remote operator input at or around the same time. In such examples, remote operation system 112 may receive requests for assistance from the vehicles 102. The requests for assistance may be prioritized within the request queue for processing by the remote operators 108. The remote operators 108 may be filtered based on their preference(s), status, operational state data associated with the vehicle, and/or the assistance requested. Additionally, or alternatively, the remote operators 108 may be filtered based on experience levels, training, experience with particular environments (e.g., geolocations, weather events, times of day, number of proximate objects including vehicles, pedestrians, etc.), situations, vehicle systems, network connection speed or latency of a particular remote operator, and so forth. In some examples, the preference(s) may be weighted differently than one another. For example, the location of the vehicle 102 may be weighted more heavily than other preferences, given a familiarity of the remote operator 108 with a particular geographical environment.

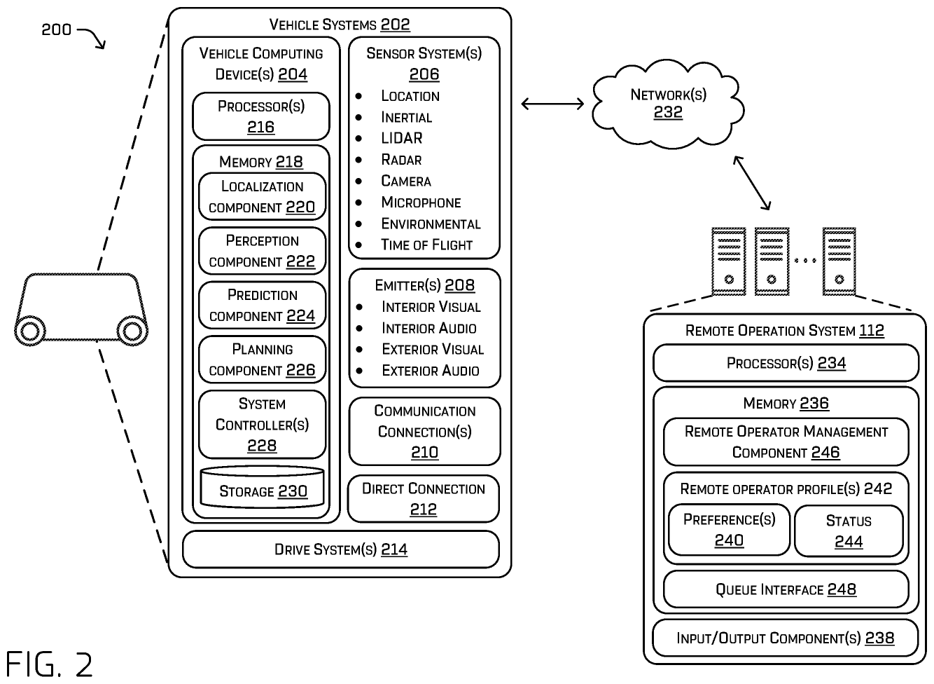

FIG. 2 is a block diagram of an architecture 200 including a vehicle system 202 for controlling operation of the systems that provide data associated with operation of the vehicle 102, and that control operation of the vehicle 102 in connection with the remote operation system 112. The vehicle system 202 can include one or more vehicle computing device(s) 204, one or more sensor system(s) 206, one or more emitter(s) 208, one or more communication connection(s) 210, at least one direct connection 212, and one or more drive system(s) 214.

The vehicle system 202 can be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such an example, since the vehicle system 202 can be configured to control all functions from start to stop, including all parking functions, it can be unoccupied. This is merely an example, and the systems and methods described herein can be incorporated into any ground-borne, airborne, or waterborne vehicle, including those ranging from vehicles that need to be manually controlled by a driver at all times, to those that are partially or fully autonomously controlled. That is, in the illustrated example, the vehicle system 202 is an autonomous vehicle; however, the vehicle system 202 could be any other type of vehicle. While only a single vehicle system 202 is illustrated in FIG. 2, in a practical application, the example system can include a plurality of vehicles, which, in some examples, can comprise a fleet of vehicles.

The vehicle computing device(s) 204, can include processor(s) 216 and memory 218 communicatively coupled with the processor(s) 216. In the illustrated example, the memory 218 of the vehicle computing device(s) 204 stores a localization component 220, a perception component 222, a prediction component 224, a planning component 226, and one or more system controller(s) 228. Additionally, the memory 218 can include a storage 230, which can store map(s), model(s), etc. As described above, a map can be any number of data structures that are capable of providing information about an environment, such as, but not limited to, topologies (such as junctions, lanes, merging zones, etc.), streets, mountain ranges, roads, terrain, and the environment in general. Maps can be associated with real environments or simulated environments.

In at least one example, the localization component 220 can determine a pose (position and orientation) of the vehicle system 202 in relation to a local and/or global map based at least in part on sensor data received from the sensor system(s) 206 and/or map data associated with a map (e.g., of the map(s)). In at least one example, the localization component 220 can include, or be associated with a calibration system that is capable of performing operations for calibrating (determining various intrinsic and extrinsic parameters associated with any one or more of the sensor system(s) 206), localizing, and mapping substantially simultaneously. Additional details associated with such a system are described in U.S. patent application Ser. No. 15/675,487, filed on Aug. 11, 2017, which is related to U.S. patent application Ser. No. 15/674,853, filed on Aug. 11, 2017, the entire contents of both of which are incorporated by reference herein.

In at least one example, the perception component 222 can perform object detection, segmentation, and/or classification based at least in part on sensor data received from the sensor system(s) 206. In at least one example, the perception component 222 can receive raw sensor data (e.g., from the sensor system(s) 206). In at least one example, the perception component 222 can receive image data and can utilize one or more image processing algorithms to perform object detection, segmentation, and/or classification with respect to object(s) identified in the image data. In some examples, the perception component 222 can associate a bounding box (or otherwise an instance segmentation) with an identified object and can associate a confidence score associated with a classification of the identified object with the identified object. In some examples, objects, when rendered via a display, can be colored based on their perceived class. The perception component 222 can perform similar processes for one or more other modalities.

The prediction component 224 can receive sensor data from the sensor system(s) 206, map data associated with a map (e.g., of the map(s) which can be in storage 230), and/or perception data output from the perception component 222 (e.g., processed sensor data), and can output predictions associated with one or more objects within the environment of the vehicle system 202. In at least one example, the planning component 226 can determine routes and/or trajectories to use to control the vehicle system 202 based at least in part on sensor data received from the sensor system(s) 206 and/or any determinations made by the perception component 222 and/or prediction component 224.

In some examples, the planning component 226 can amalgamate (e.g., combine) operation state data from the data it obtains and/or from the correlated data it determines. For example, the operation state data may include: a representation of sensor data; detected object/event data that includes: a location of a detected object, a track of the detected object (e.g., a position, velocity, acceleration, and/or heading of the object), a classification (e.g., a label) of the detected object (for example, including sub-classes and subsets of classifications as discussed above), an identifier of a detected event, a confidence level (e.g., a percentage, an indicator that a classification and/or an identifier of a detected event is associated with an indicator of high unpredictability or low confidence), a rate of change of confidence levels over time, and/or a priority associated with the object(s) and/or event; path planning data that includes: a route, a progress of the vehicle along the route, a mission type (e.g., stop for additional passengers, pick up and deliver one passenger), passenger input, a trajectory, a pose of the vehicle, a geographic location of the autonomous vehicle, and/or a trajectory determined by the vehicle; vehicle state information that includes: a number of passengers occupying the vehicle, passenger input (e.g., speech, passenger state), an indication of vehicle and/or sensor health, an indication of vehicle history (e.g., past routes, past requests for assistance, past maintenance), a charge level of a battery of the vehicle, a distance of the vehicle from a fleet base of operations or charging station, an indication of whether a communication session is open between the vehicle and a remote operator device(s) and/or another vehicle, vehicle control data, a vehicle type (e.g., make, model, size, etc.), road network data (e.g., data related to a global or local map of an area associated with operation of the vehicle such as, for example, a location of the vehicle within a local map and/or an indication of whether vehicle data is normative for the location (e.g., whether a vehicle speed is above or below a speed limit indicated by the road network data, whether the vehicle is stopped at a position that is identified as being a stop location, whether the vehicle is within a predefined distance of a fleet-wide event)), communication channel information (e.g., bandwidth and/or quality of connection, identification of device(s) to which the vehicle is connected, predicted communication channel degradation), and/or previous remote operator guidance to the vehicle (e.g., direct instruction, collaboration, and/or confirmation); environmental data (e.g., in some examples this may be included in the representation of the sensor data or it may be acquired via the network interface) that includes: traffic information, weather information, city/regional events (e.g., acquired from social media, publications), time of day, and/or road network data (e.g., a processor-executable map accessible to the vehicle that identifies geographical locations as being a normal driving area, a drivable area, speed limits associated with geographical regions, event locations (e.g., accident location, location from which multiple requests have been sent), and/or an undriveable area and/or containing operating policies for a vehicle to operate therein).

In some examples, the planning component 226 may use at least a portion of the sensor data and/or the operation state data to determine a next action of the vehicle system 202 such as, for example, a trajectory and/or whether to send a request for assistance.

Additional details of localization systems, perception systems, prediction systems, and/or planning systems that are usable can be found in U.S. Pat. No. 9,612,123, issued on Apr. 4, 2017, and U.S. Pat. No. 10,353,390, issued on Jul. 16, 2019, the entire contents of both of which are incorporated by reference herein. In some examples (e.g., where the vehicle system 202 is not an autonomous vehicle), one or more of the aforementioned systems can be omitted from the vehicle system 202. While the systems described above are illustrated as “onboard” the vehicle system 202, in other implementations, the systems can be remotely located and/or accessible to the vehicle system 202. Furthermore, while the systems are described above as “systems,” such systems can comprise one or more components for performing operations attributed to each of the systems.

In at least one example, the localization component 220, the perception component 222, the prediction component 224, and/or the planning component 226 can process sensor data, as described above, and can send their respective outputs over network(s) 232, to computing device(s) of the remote operation system 112. In at least one example, the localization component 220, the perception component 222, the prediction component 224, and/or the planning component 226 can send their respective outputs to the computing device(s) of the remote operation system 112 at a particular frequency, after a lapse of a predetermined period of time, in near real-time, etc.

In at least one example, the vehicle computing device(s) 204 can include one or more system controller(s) 228, which can be configured to control steering, propulsion, braking, safety, emitters, communication, and other systems of the vehicle system 202. These system controller(s) 228 can communicate with and/or control corresponding systems of the drive system(s) 214 and/or other systems of the vehicle system 202.

In at least one example, the sensor system(s) 206 can include lidar sensors, radar sensors, ultrasonic transducers, sonar sensors, location sensors (e.g., GPS, compass, etc.), inertial sensors (e.g., inertial measurement units, accelerometers, magnetometers, gyroscopes, etc.), cameras (e.g., RGB, IR, intensity, depth, etc.), wheel encoders, audio sensors, environment sensors (e.g., temperature sensors, humidity sensors, light sensors, pressure sensors, etc.), ToF sensors, etc. The sensor system(s) 206 can include multiple instances of each of these or other types of sensors. The sensor system(s) 206 can provide input to the vehicle computing device(s) 204. In some examples, the sensor system(s) 206 can preprocess at least some of the sensor data prior to sending the sensor data to the vehicle computing device(s) 204. In at least one example, the sensor system(s) 206 can send sensor data, via network(s) 232, to the remote operation system 112 at a particular frequency, after a lapse of a predetermined period of time, in near real-time, etc.

The vehicle system 202 can also include one or more emitter(s) 208 for emitting light and/or sound, as described above. The emitter(s) 208 in this example include interior audio and visual emitters to communicate with passengers of the vehicle system 202. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 208 in this example also include exterior emitters. By way of example and not limitation, the exterior emitters in this example include light emitters (e.g., indicator lights, signs, light arrays, etc.) to visually communicate with pedestrians, other drivers, other nearby vehicles, etc., one or more audio emitters (e.g., speakers, speaker arrays, horns, etc.) to audibly communicate with pedestrians, other drivers, other nearby vehicles, etc., etc. In at least one example, the emitter(s) 208 can be positioned at various locations about the exterior and/or interior of the vehicle system 202.

The vehicle system 202 can also include communication connection(s) 210 that enable communication between the vehicle system 202 and other local or remote computing device(s). For instance, the communication connection(s) 210 can facilitate communication with other local computing device(s) on the vehicle system 202 and/or the drive system(s) 214. Also, the communication connection(s) 210 can allow the vehicle to communicate with other nearby computing device(s) (e.g., other nearby vehicles, traffic signals, etc.). The communications connection(s) 210 also enable the vehicle system 202 to communicate with a remote operation system 112 or other remote services.

The communications connection(s) 210 can include physical and/or logical interfaces for connecting the vehicle computing device(s) 204 to another computing device or a network, such as network(s) 232. For example, the communications connection(s) 210 can enable Wi-Fi-based communication such as via frequencies defined by the IEEE 802.11 standards, short range wireless frequencies such as BLUETOOTH®, or any suitable wired or wireless communications protocol that enables the respective computing device to interface with the other computing device(s).

The direct connection 212 can directly connect the drive system(s) 214 and other systems of the vehicle system 202.

In at least one example, the vehicle system 202 can include drive system(s) 214. In some examples, the vehicle system 202 can have a single drive system 214. In at least one example, if the vehicle system 202 has multiple drive system(s) 214, individual drive system(s) 214 can be positioned on opposite ends of the vehicle system 202 (e.g., the front and the rear, etc.). In at least one example, the drive system(s) 214 can include sensor system(s) to detect conditions of the drive system(s) 214 and/or the surroundings of the vehicle system 202. By way of example and not limitation, the sensor system(s) can include wheel encoder(s) (e.g., rotary encoders) to sense rotation of the wheels of the drive module, inertial sensors (e.g., inertial measurement units, accelerometers, gyroscopes, magnetometers, etc.) to measure position and acceleration of the drive module, cameras or other image sensors, ultrasonic sensors to acoustically detect objects in the surroundings of the drive module, lidar sensors, radar sensors, etc. Some sensors, such as the wheel encoder(s), can be unique to the drive system(s) 214. In some cases, the sensor system(s) on the drive system(s) 214 can overlap or supplement corresponding systems of the vehicle system 202 (e.g., sensor system(s) 206).

The drive system(s) 214 can include many of the vehicle systems, including a high voltage battery, a motor to propel the vehicle system 202, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 214 can include a drive module controller which can receive and preprocess data from the sensor system(s) and to control operation of the various vehicle systems. In some examples, the drive module controller can include processor(s) and memory communicatively coupled with the processor(s). The memory can store one or more modules to perform various functionalities of the drive system(s) 214. Furthermore, the drive system(s) 214 also include communication connection(s) that enable communication by the respective drive module with other local or remote computing device(s).

In FIG. 2, the vehicle computing device(s) 204, sensor system(s) 206, emitter(s) 208, and the communication connection(s) 210 are shown onboard the vehicle system 202. However, in some examples, the vehicle computing device(s) 204, sensor system(s) 206, emitter(s) 208, and the communication connection(s) 210 can be implemented outside of an actual vehicle (i.e., not onboard the vehicle system 202).

As shown in FIG. 2, the vehicle system 202 are configured to establish a communication link between the vehicle system 202 and one or more other devices. For example, the network(s) 232 may be configured to allow data to be exchanged between the vehicle system 202, other devices coupled to a network, such as other computer systems, other vehicles systems 202 in the fleet of vehicles, and/or with the remote operation system 112. For example, the network(s) 232 may enable wireless communication between numerous vehicles and/or the remote operation system 112. In various implementations, the network(s) 232 may support communication via wireless general data networks, such as a Wi-Fi network. For example, the network(s) 232 may support communication via telecommunications networks, such as, for example, cellular communication networks, satellite networks, and the like.

The remote operation system 112 can include processor(s) 234, memory 236, and input/output component(s) 238. The remote operation system 112 is configured to receive information (e.g., data) from vehicles as well as requests for assistance. The remote operation system 112 is configured to receive the data and the requests from a fleet of vehicle systems 202. The fleet of vehicles may convey, at or around the same time, the data and/or the requests for assistance. The data allows the remote operation system 112 to discover all vehicles as well as their status. For example, upon receipt of the data, the remote operation system 112 may understand where the vehicles are located, a current state of vehicle, such as speed, heading, location, whether a remote operator is connected to the vehicle, health status of modems, a mission type of the vehicle, and so forth. In some examples, knowing the location of the vehicle, the remote operation system 112 may determine a geofence of the vehicle, or what geofence the vehicle is in. The geofence, in some examples, may be associated with a city, town, municipal, and the like, a geographical area, blocks, zip codes, and so forth. Discussed herein, the geofence may be used to match requests for assistance with a remote operator, given a familiarity or preference of the remote operator. In some examples, the data may be received on a continual and predetermined basis, such as every 100 milliseconds, every second, and so forth.

The remote operation system 112 may also store preference(s) 240 of the remote operators 108 within remote operator profile(s) 242. In some examples, the preference(s) 240 may be added, deleted, modified, or otherwise provided by the remote operators 108. For example, the remote operators 108 may provide indications of the types of vehicles they wish to provide assistance to, within what geofences (e.g., geographical areas) the remote operators 108 wish to provide assistance, any associated specialization or training (e.g., special knowledge of HVAC systems, or other subcomponents, passenger interaction training, etc.), the types of mission the remote operators 108 prefer to provide assistance, the type of assistance the remote operators 108 wish to provide, and so forth. The remote operators 108 may provide other preference(s) as well.

Additionally, the remote operator profile(s) 242 may store a status 244 of the remote operators. The status 244, in some examples, may indicate an availability of the remote operators, such as whether the remote operators 108 are on-duty, off-duty, on a break, in training mode, already providing assistance, and so forth. The status 244 of the remote operators 108 may be continuously updated for knowing a current state of the remote operators and whether they are able to provide assistance.

The remote operation system 112 includes a remote operations management component 246 that manages requests for assistance, and selects remote operators 108 for responding to the requests. For example, the remote operations management component 246 may receive the requests for assistance via a queue interface 248. In some examples, the queue interface 248 stores, or otherwise logs, the requests as received from the vehicles. The requests may be sorted based on a time at which they are received, a level of criticality in responding to the requests, and so forth. The remote operations management component 246 communicates with one or more remote operators to convey the requests for processing. As part of communicating or sending the requests to the remote operators 108, the remote operations management component 246 may utilize the preference(s) 240 and/or the status 244 stored in association with the remote operator profile(s) 242, as well as the data and/or specifics of the request for assistance received from the vehicles. As above, such a queue interface 248 may store multiple queues with an individual one of which being associated with one or more criteria (which may be a set or subset of those associated with the remote operators 108).

The processor(s) 216 of the vehicle system 202 and the processor(s) 234 of the remote operation system 112 can be any suitable processor capable of executing instructions to process data and perform operations as described herein. By way of example and not limitation, the processor(s) 216 and 234 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

Memory 218 and 236 are examples of non-transitory computer-readable media. Memory 218 and 236 can store an operating system and one or more software applications, instructions, programs, and/or data to implement the methods described herein and the functions attributed to the various systems. In various implementations, the memory can be implemented using any suitable memory technology, such as static random receive memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

In various implementations, the parameter values and other data illustrated herein may be included in one or more data stores and may be combined with other information not described or may be partitioned differently into more, fewer, or different data structures. In some implementations, data stores may be physically located in one memory or may be distributed among two or more memories.

Those skilled in the art will appreciate that the architecture 200 is merely illustrative and is not intended to limit the scope of the present disclosure. In particular, the computing system and devices may include any combination of hardware or software that may perform the indicated functions, including computers, network devices, internet appliances, tablet computers, PDAs, wireless phones, pagers, etc. The architecture 200 may also be connected to other devices that are not illustrated, or instead may operate as a stand-alone system. In addition, the functionality provided by the illustrated components may in some implementations be combined in fewer components or distributed in additional components. Similarly, in some implementations, the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated architecture 200. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from the architecture 200 may be transmitted to the architecture 200 via transmission media or signals such as electrical, electromagnetic, or digital signals, conveyed via a communication medium such as a wireless link. Various implementations may further include receiving, sending, or storing instructions and/or data implemented in accordance with the foregoing description on a computer-accessible medium. Accordingly, the techniques described herein may be practiced with other control system configurations. Additional information about the operations of the modules of the vehicle system 202 is discussed below.

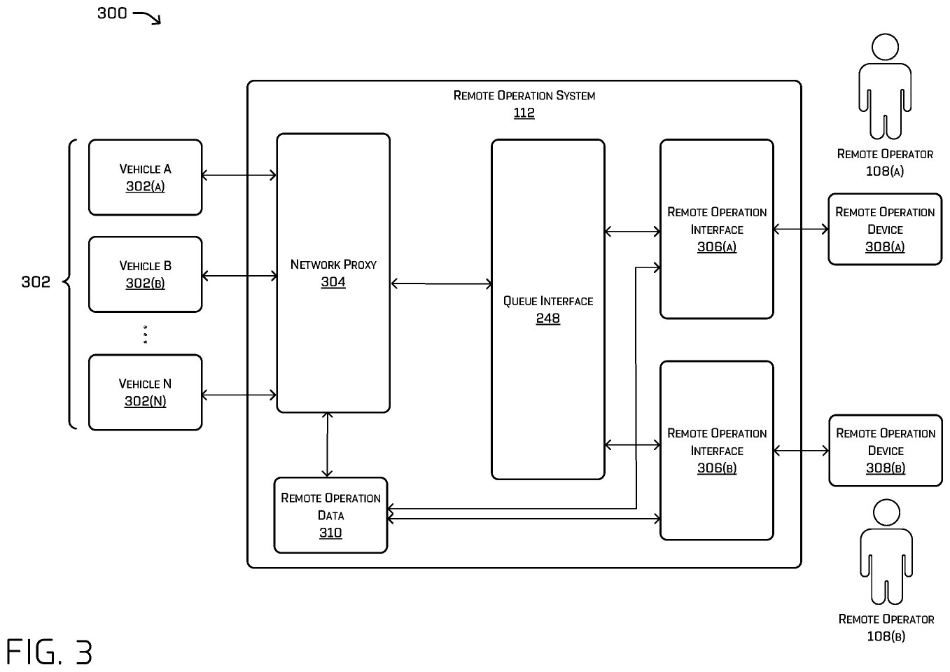

FIG. 3 shows an example architecture 300 including a vehicle fleet 302, including vehicle 302(a), vehicle 302(b), . . . vehicle 302(n) (where n is any integer greater than or equal to two), and the remote operation system 112. The vehicle fleet 302 may include one or more vehicles 302(a), 302(b), . . . 302(n), at least some of which are communicatively coupled to the remote operation system 112 via network interfaces of the respective vehicles. However, although the vehicle fleet 302 is described, it is to be understood that only a single vehicle may be included.

A network proxy 304 of the remote operation system 112 may be communicatively coupled to the network interfaces of the vehicles. For example, a vehicle 302(a) may send communication signals via the network interface, which are received by the network proxy 304. In some examples, the communication signals may include, for example, sensor data from one or more sensors associated with the vehicles, operational state data, and/or a request for assistance, though any data and/or output from one or more modules of the vehicle systems 202 is contemplated.

As shown in FIG. 3, the queue interface 248 may receive the requests from the network proxy 304 and associate them with a queue. The queue interface 248 may process the requests for selecting one or more remote operators, e.g., by removing the highest priority, oldest, most critical, etc. requests from the queue and identifying those remote operators having closest matching criteria and acceptable associated statuses such as a first remote operator 108(a) and a second remote operator 108(b) to respond to the requests. In some examples, the queue interface 248 may directly communicate with the vehicle fleet 302. While only two remote operators 108 are shown in this example, in practice, any number of remote operators 108 may be associated with the remote operation system 112 to respond to the requests. Additionally, in some examples, the remote operators 108 associated with the remote operation system 112 may be co-located in a same remote operations center, may be located in multiple disparately located remote operations centers, and/or may be individually located (e.g., working from home).

In some examples, the queue interface 248 may be implemented on a device that is separate from a device that includes a remote operator interface 306. For example, the queue interface 248 may include a gateway device and an application programming interface (“API”) or similar interface. In some examples, the queue interface 248 is configured to receive the requests and generate a queue for the requests for processing by the remote operators 108. The queue interface 248 may match the requests with corresponding remote operators 108 based on sensor data generated by the vehicles, preference(s) of the remote operators 108, a status of the remote operators 108, and so forth. In such examples, the queue interface 248 may filter available remote operators 108 for assigning requests based on the availability of the remote operators 108. In an example, the queue interface 248 may prioritize requests based on a first come, first served basis, with requests having earlier timestamps prioritized above more recent requests. The queue interface 248 may also apply filters to adjust priority a priority in which the requests are assigned, for example, based on safety determinations (e.g., speed of the vehicle or environmental conditions), passenger status (e.g., occupied versus unoccupied), a proximity of the remote operators to the vehicle, and other such filters.

The queue interface 248 may be configured to load balance the requests among the remote operators 108. For example, if more than one remote operator 108 can respond to the request (e.g., based on the preference(s) 240, status 244, etc.), the queue interface 248 may send the request to a remote operator who has responded to the lesser number of requests. In some examples, this may be over a predetermined amount of time, such as a working shift, day, month, and so forth. Additionally, as part of sending the request to the remote operator 108, the remote operator 108 may have a predetermined amount of time to respond to or accept the request. If the response is received within the predetermined amount of time, the queue interface 248 may assign the request to the remote operator 108. If the request is not received within the predetermined amount of time, the queue interface 248 may determine another remote operator 108 for responding to the request.

In some examples, the queue interface 248 may maintain multiple different or separate queues that may operate in parallel to one another. In such examples, the separate parallel queues may correspond to different geographic locations of the vehicles, different vehicle types, different request types (e.g., requesting guidance assistance versus a request from a passenger of the vehicle system), and other queues related to different filters for the queues may also be applied. The multiple parallel queues may each be accessible by distinct subsets of remote operators, for example with a queue for a first vehicle type only accessible to remote operators qualified to provide guidance or assistance to that class of vehicle. In some examples, the remote operators may be available to handle requests from one or more of the parallel queues.

The queue interface 248 communicates with the remote operator interfaces 306 of the remote operation system 112. The queue interface 248 generates the queue of requests and communicates the requests to the remote operators 108 via the remote operator interface 306. Each of the remote operators 108 may include a respective remote operation device (e.g., tablet, complete, phone, etc.) for communicating with the remote operation system 112 and responding to the requests. For example, the first remote operator 108(a) may use a remote operator device 308(a), while the second remote operator 108(b) may use a remote operator device 308(b). In some examples, the network proxy 304 may be communicatively coupled to the remote operator interface 306 via the queue interface 248, and in some examples, the remote operator 108 may be able to access the sensor data, the operation state data, and/or any other data in the communication signals received from the vehicle 302(a), 302(b), . . . 302(n) via the remote operator interface 306.

The remote operators 108 have the ability to accept or deny the requests for assistance. For example, upon the queue interface 248 selecting a remote operator for responding to the request, an indication of such may be sent to the remote operator devices 308. In response, the remote operator 108 may choose to either accept or deny the request. As part of this, the remote operator 108 may selectively access the sensor data, operation state data, and/or other data via the remote operator device 308, and view the selected data via one or more of the displays (see FIG. 1). In some examples, the remote operator 108 may have a predetermined amount of time to accept the request, and if not, another remote operator 108 may be determined for responding to the request.

The remote operation system 112 may provide communication between two or more of the remote operator interfaces 306 and the respective remote operators 108 (e.g. via the remote operator device 308), and/or communication with remote operation data 310. For example, the remote operation system 112 may include a plurality of remote operator interfaces 306 associated with respective remote operators 108, and the remote operators 108 may communicate with one another to facilitate and/or coordinate the guidance provided to the vehicles of the vehicle fleet 302. In some examples, data associated the guidance provided by a remote operator 108 may be stored by the remote operation system 112, for example, in remote operation data 310. In some examples, the remote operation data 310 may be accessible by the remote operators 108, for example, via the remote operator interface 306, for use in providing guidance to the vehicles.

The remote operation data 310 may include sensor data and other operating data from the vehicle fleet 302 and may be accessed by the remote operators 108 at the remote operator interface 306 without passing the remote operation data 310 through the queue interface 248. In this manner, the queue interface 248 may receive basic information related to the identity of the vehicle making the request and the assistance required. Upon selection of a remote operator 108, the remote operator 108 establishes a direct communication channel with the vehicle that bypasses the queue interface 248. The bypass may enable faster communication with lower latency due to potentially high volumes of traffic (e.g., information) on the queue interface 248.

In some examples, the remote operation data 310 may include global and/or local map data related to a road network of an environment of the vehicle, events associated with the road 4, and/or travel conditions associated with the road due to, for example, traffic volume, weather conditions, construction zones, and/or special events. In some examples, the remote operation data 310 may include data associated with one more of the vehicles of the vehicle fleet 302, such as, for example, maintenance and service information, and/or operational history including, for example, event history associated with the vehicle, route histories, occupancy histories, and other types of data associated with the vehicle.

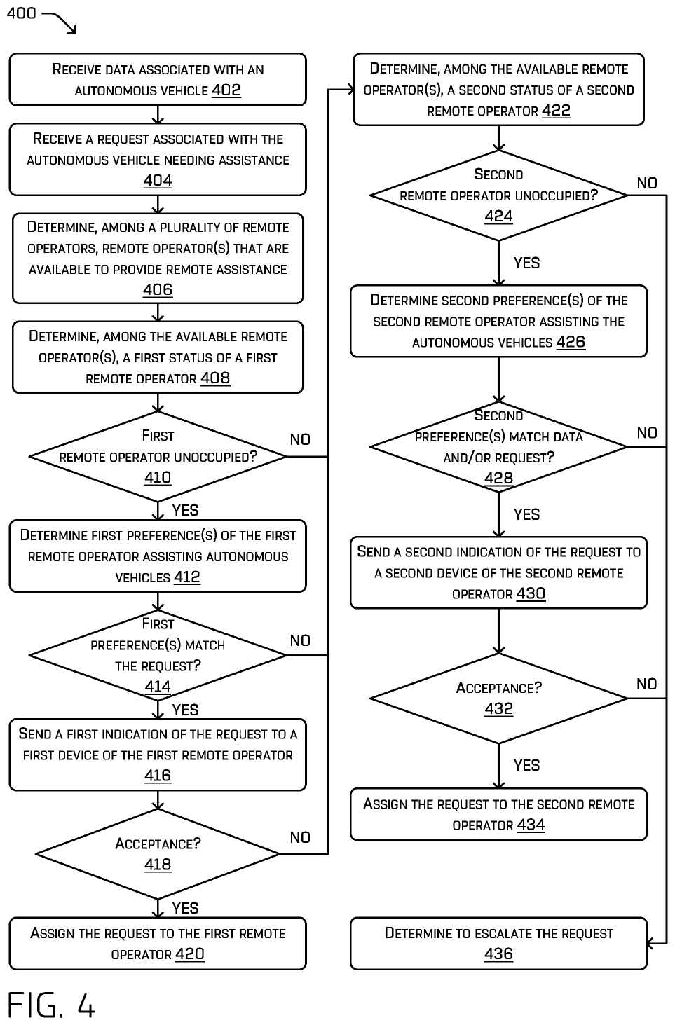

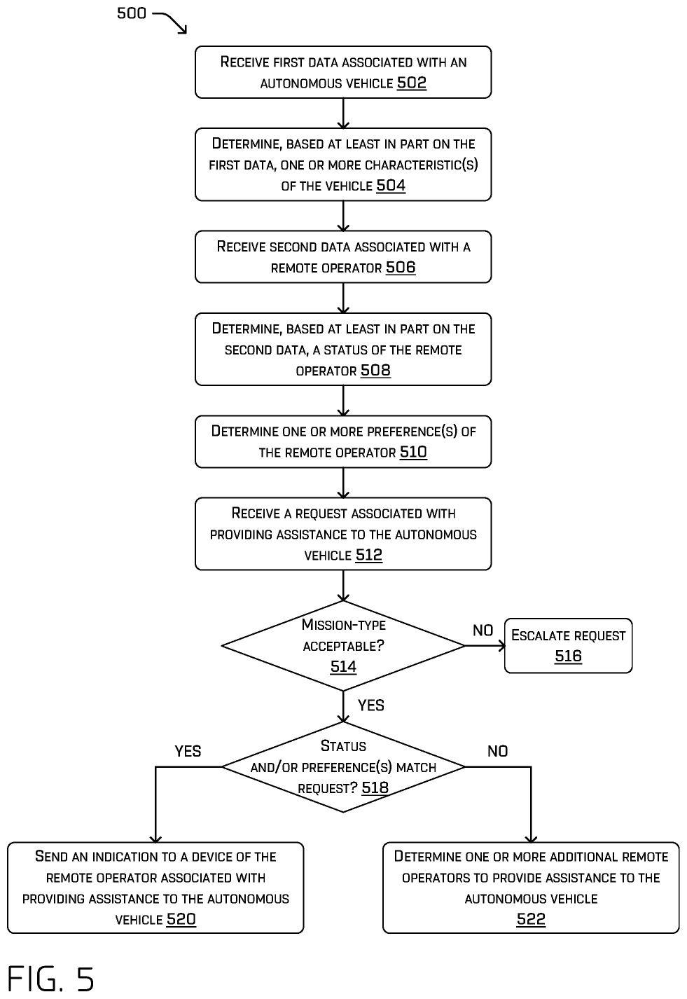

FIGS. 4 and 5 illustrate various processes related to providing vehicles with remote assistance. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-3, although the processes may be implemented in a wide variety of other environments, architectures and systems.

FIG. 4 illustrates an example process 400 for determining a remote operator to provide assistance to a vehicle.

At 402, the process 400 may include receiving data associated with an autonomous vehicle. For example, the remote operation system 112 may receive data from the vehicle 102 that indicates an operational state of the vehicle 102. In some examples, the data may include or represent a state of vehicle, such as speed, heading, location, whether a remote operator is connected to/communicating with the vehicle, a mission type of the vehicle (e.g., training missions, recharging, transporting passengers, etc.). Such data may be received on a continual and/or periodic basis according to a predetermined schedule. In some examples, knowing the location of the vehicle is used to determine a geofence in which the vehicle recites, such as a city local, zip code, area, region, and so forth. Such data may additionally or alternately comprise voice and/or image data from one or more passengers, raw sensor data from one or more sensors, derivative data from the one or more sensors, log data from one or more messages between various hardware and/or software components, a request from a passenger input via an interface onboard the vehicle and/or from the passenger's personal device, or the like.

At 404, the process 400 may include receiving a request associated with the autonomous vehicle needing assistance. For example, in response to certain events or the autonomous vehicle encountering trouble, the autonomous vehicle may request assistance. In some examples, the request may specify the type of assistance required, the event experienced by the vehicle, a vehicle type, passenger status, and/or other such information from the vehicle. As part of receiving the request, as well as requests from other vehicles, the remote operation system 112 may generate a queue. For example, the queue may be generated by the queue interface 248 as described herein by prioritizing the requests as received from the vehicles.

At 406, the process 400 may include determining, among a plurality of remote operators, remote operator(s) that are available to provide remote assistance. For example, among the plurality of remote operators that provide remote assistance, only a subset of these remote operators may be available. For example, the remote operators may be offline, not logged into the remote operation system 112 to provide assistance, and so forth. In such instances, these remote operators may be unavailable to provide assistance. Comparatively, the remote operators that are online, logged into the remote system 112, and so forth, may be available to provide assistance. In some examples, the remote operation system 112 may receive indications of the availability of the remote operators 108, indicating whether the remote operators 108 are online. Such indications may be received when the remote operators 108 log into the remote operation system 112, set an availability, and so forth.

At 408, the process 400 may include determining, among the available remote operators, a first status of a first remote operator. For example, the remote operation system 112 may have access to the remote operator profile of the first remote operator for determining the status of the first remote operator. Such status may indicate whether the first remote operator is in training, providing assistance to another vehicle, on a break, unavailable to receive requests, and so forth. That is, even though the first remote operator is available (e.g., online), the first remote operator may be busy, such as providing assistance to another vehicle.

At 410, the process 400 may include determining whether the first remote operator is unoccupied. Whether the first remote operator is unoccupied is determined from the first status. For example, if the first remote operator is being trained, the first remote operator may be determined to be occupied. If the first remote operator is already assisting another vehicle, the first remote operator may be determined to be occupied. If the first remote operator is on a break, the first remote operator may be determined to be occupied. The remote operation system 112 may continuously receive indications of the first status of the first remote operator to know whether the first remote operator is unoccupied (or occupied). Still, the first remote operator may have the ability to set their status, for example, indicating that they are on break. Comparatively, if the first remote operator is not assisting other vehicles, the first remote operator may be determined to be unoccupied.

If at 410 the process 400 determines that the first remote operator is unoccupied, the process 400 may follow the “YES” route and proceed to 412. At 412, the process 400 may include determining first preference(s) of the first remote operator assisting autonomous vehicles. For example, the preference(s) stored in association with the first remote operator may be accessed. This may indicate, for example, geographical area(s) that the first remote operator provides assistance, types of assistance that the first remote operator provides, types of vehicles that the first remote operator provides assistance to, and so forth. The first remote operator has the ability to set or determine the preferences that are used when assigning the requests.

At 414, the process 400 may include determining whether the first preference(s) match the request and/or a degree to which the preferences match. For example, the process 400 may compare the preference(s) of the first remote operator with the data as received from the vehicle and/or the request. For example, knowing a location of the vehicle, the process 400 may determine whether the vehicle is within a geographical area serviced by the first remote operator. Additionally, or alternatively, the type of assistance that the vehicle is requesting may be compared against the types of assistance that the first remote operator provides. In some examples, any number of preference(s) may be compared (e.g., experience, location of the remote operator, etc.) for determining whether the preference(s) match the request. In some examples, the preference(s) may have to match the request identically, or above a certain threshold, for determining whether the preference(s) match the request. In some examples, the selection may be based on the first remote operator matching more preferences than any other currently available remote operator.

Generally, the preference(s) may be associated with filters that are used to filter the remote operators to select a remote operator to provide assistance to the vehicle. Such filters, as noted above, may include a status of the first remote operator and/or a geographical location of the first remote operator, as well as number of requests processed, experience with providing assistance, physical proximity to the vehicle may be selected to reduce latency, mission-type, and other remote operator defined preference(s).

In some examples, the remote operation system 112 may include multiple remote operation centers, with remote operation centers scattered around a geographic region where a fleet of vehicles operate. In such examples, the remote operators may be selected based on proximity to the vehicle requesting assistance. In some examples, the remote operation centers may have different bandwidths and/or availability to handle the requests. To reduce latency, in some examples, a nearest remote operation center and/or remote operator may be selected to process a request.

If at 414 the process 400 determines that the preference(s) match the request, the process 400 may follow the “YES” route and proceed to 416.

At 416, the process 400 may include sending a first indication of the request to a first device of the first remote operator. For example, the remote operation system 112 may send an indication of the request to a first device of the first remote operator. In some examples, the indication may display information associated with the request and the vehicle, such as location, type of assistance needed, and so forth. The first indication serves as a notification to the first remote operator as to whether to accept or deny the request to provide assistance to the vehicle.

At 418, the process 400 may include determining whether there was an acceptance of the request. For example, the remote operation system 112 may determine whether the first remote operator accepted the request to provide assistance to the vehicle. In some examples, the first remote operator may have a predetermined amount of time (e.g., 5 seconds) to respond to the first indication and accept the request. If the acceptance is received before the predetermined amount of time, the request may be assigned to the first remote operator. If the acceptance is received after the predetermined amount of time, or the acceptance is not received prior to the predetermined amount of time elapsing, the request may have determined to have not been accepted. If at 418 the acceptance is received, the process 400 may follow the “YES” route and proceed to 420.

At 420, the process 400 may include assigning the request to the first remote operator. As part of assigning the request to the remote operator, the first remote operator may be connected the vehicle to provide assistance and/or control the vehicle. Here, the status of the first remote operator may be updated to indicate that the first remote operator is providing assistance, and thus, is occupied. This may be used when assigning additional requests, for example, knowing that the first remote operator is busy and unable to accept further requests. Additionally, when the first remote operator accepts a request, the first remote operator may receive sensor data and view the event or situation encountered by the vehicle to provide input accordingly. As part of controlling the vehicle, the remote operation system 112 may transmit a request to have the vehicle switch to manual. In some examples, the switch may be rejected, for example in a case where a remote operator is identified and accepts a request, however, the vehicle has already resolved the situation and no longer requests assistance. In some examples, after assigning the request, the request may be removed from the queue interface to avoid the request remaining on the queue interface.

In some examples, as part of assigning the request to the first remote operator, an indication may be output within the vehicle. For example, the indication may indicate that a remote operator has connected to the vehicle and will be providing assistance. The indication may be output on speakers of the vehicle, a display, and so forth. In some examples, the first remote operator is allowed to communicate with passengers in the vehicle.

The process 400 illustrates that following the “NO” route from 410, 414, or 418, the process 400 may proceed to 422. For example, if the first operator is occupied, if the first preference(s) do not match the request, and/if the request is not accepted by the first remote operator, the process 400 may proceed to 422.

At 422, the process 400 may include determining a second status of a second remote operator. For example, the remote operation system 112 may have access to the remote operator profile of the second remote operator for determining the status of the second remote operator. Such status may indicate whether the second remote operator is in training, providing assistance to another vehicle, on a break, unavailable to receive requests, and so forth. That is, even though the second remote operator is available (e.g., online), the first remote operator may be busy, such as providing assistance to another vehicle.

At 424, the process 400 may include determining whether the second remote operator is unoccupied. Whether the second remote operator is unoccupied is determined from the second status. For example, if the second remote operator is being trained, the second remote operator may be determined to be occupied. If the second remote operator is already assisting another vehicle, the second remote operator may be determined to be occupied. If the second remote operator is on a break, the second remote operator may be determined to be occupied. The remote operation system 112 may continuously receive indications of the second status of the second remote operator to know whether the second remote operator is unoccupied (or occupied). Still, the second remote operator may have the ability to set their status, for example, indicating that they are on break. Comparatively, if the second remote operator is on-duty and is not assisting other vehicles, the second remote operator may be determined to be unoccupied.

If at 424 the process 400 determines that the second remote operator is unoccupied, the process 400 may follow the “YES” route and proceed to 426. At 426, the process 400 may include determining second preference(s) of the second remote operator assisting autonomous vehicles. For example, the preference(s) 240 stored in association with the second remote operator may be accessed. This may indicate, for example, geographical area(s) that the second remote operator provides assistance, types of assistance that the second remote operator provides, types of vehicles that the second remote operator provides assistance to, and so forth. The second remote operator has the ability to set or determine the preferences that are used when assigning the requests.

At 428, the process 400 may include determining whether the second preference(s) match the request. For example, the process 400 may compare the preference(s) of the second remote operator with the data as received from the vehicle and/or the request. For example, knowing a location of the vehicle, the process 400 may determine whether the vehicle is within a geographical area serviced by the second remote operator. Additionally, or alternatively, the type of assistance that the vehicle is requesting may be compared against the types of assistance that the second remote operator provides. In some examples, any number of preference(s) may be compared (e.g., experience, location of the remote operator, etc.) for determining whether the preference(s) match the request.

If at 428 the process 400 determines that the preference(s) match the request, the process 400 may follow the “YES” route and proceed to 430.

At 430, the process 400 may include sending a second indication of the request to a second device of the second remote operator. For example, the remote operation system 112 may send an indication of the request to a second device of the second remote operator. In some examples, the second indication may display information associated with the request and the vehicle, such as location, type of assistance needed, and so forth. The second indication serves as a notification to the second remote operator as to whether to accept or deny the request to provide assistance to the vehicle.

At 432, the process 400 may include determining whether there was an acceptance of the request. For example, the remote operation system 112 may determine whether the second remote operator accepted the request to provide assistance to the vehicle. In some examples, the second remote operator may have a predetermined amount of time (e.g., 5 seconds) to respond to the second indication and accept the request. If at 432 the acceptance is received, the process 400 may follow the “YES” route and proceed to 434.

At 434, the process 400 may include assigning the request to the second remote operator. As part of assigning the request to the second remote operator, the second remote operator may be connected the vehicle 102 to provide assistance and/or control the vehicle. Additionally, when the second remote operator accepts a request, the second remote operator may receive sensor data and view the event or situation encountered by the vehicle to provide input accordingly.

The process 400 illustrates that following the “NO” route from 424, 428, or 432, the process 400 may proceed to 436. For example, if the second operator is not available, if the second preference(s) do not match the request, and/if the request is not accepted by the second operator, the process 400 may proceed to 436.

At 436, the process 400 may include determining to escalate the request. For example, if the request does not match any preference(s) of the remote operators 108, the remote operation system 112 may determine to escalate the request to avoid having the request backlog the queue interface 248. Escalating the request may forward the request to remote operators, or other observers, which analyze the request and determine why no remote operators were matched to the request. In such examples, the request may be deleted (or removed) from the queue interface 248, or the remote operators may manually process (e.g., filter) the request. In other examples, the request may be updated or otherwise modified such that the request is matched to one or more remote operators. In some examples, those requests that were not matched with remote operators may be logged to determine the absence of remote operators that met the request.

Although the process 400 describes determining whether the request matches preferences of a two remote operators, the preference(s) of any number of remote operators may be compared to the request. For example, the process 400 may repeat to see if third preferences of a third remote operator match the request, as well as if the third remote operator is available. In such instances, the request may be broadcasted to any number of remote operators, and the first operator to respond may assigned the request. For example, if the request is not assigned to the first remote operator, whether because they are busy, the preferences do not match, and so forth, the remote operation system 112 may determine other remote operators that are available to respond to the requests. In some examples, the requests may be sent in parallel to the other remote operators, assuming they are unoccupied, their preference(s) match, and so forth, and the first remote operator to respond to the request may be assigned to the requests. In this manner, the operations 422-432 may be performed in parallel for any number of remote operators. For example, the remote operations system 112 may determine a third remote operator among the available remote operations, and send a request to the third remote operator in parallel with the second remote operator. Here, both remote operators may match the request and be suitable for providing assistance.

In some examples, the process 400 may additionally or alternatively include receiving criteria associated with which to match the remote operators to the requests for assistance. For example, the criteria may be used to filter those remote operators who are available and selected to respond to the request for assistance. In some examples, the criteria may be a configurable (e.g., customizable) strategy to pick an available remote operator that matches the filters for routing the request to the remote operator. By way of illustration, a first filter may include filtering the remote operators based on a type of vehicle, and a second filter may include filtering the remote operators based on a geographical area serviced by the remote operators. Such filters may then include determining which remote operators are available. However, any number of filters may be used to determine the available remote operators, the filters may be applied in any order, and the filters may include different filters that those described herein. In examples, the filters and/or the number of filters may be selected based on the type of assistance requested.

FIG. 5 illustrates an example process 500 for determining a remote operator to provide assistance to a vehicle.

At 502, the process 500 may include receiving first data associated with an autonomous vehicle. For example, the remote operation system 112 may receive data from the vehicle that indicates an operational states of the vehicle 102. Such data may be received on a continual and/or periodic basis according to a predetermined schedule.

At 504, the process 500 may include determining one or more characteristic(s) of the vehicle based at least in part on the first data. For example, the one or more characteristic(s) may include a speed, direction, location, whether a remote operator is connected to/communicating with the vehicle, a mission type of the vehicle (e.g., training missions, recharging, transporting passengers, etc.). In some examples, the one or more characteristic(s) may include a geofence in which the vehicle resides, such as a city local, zip code, area, region, and so forth.

At 506, the process 500 may include receiving second data associated with a remote operator. In some examples, the second data may indicate an availability of the remote operator, a status of the remote operator, and/or one or more preference(s) of the remote operator. For example, the remote operator may provide the preference(s) when providing assistance to vehicles. In some examples, such preference(s) may indicate vehicle types, vehicle locations (e.g., within a certain geofence), and so forth. In some examples, the status of the remote operator may be automatically received from the remote operator (or a device of the remote operator) according to a predetermined schedule such that the status is up-to-date.

At 508, the process 500 may include determining, based at least in part on the second data, a status of the remote operator. For example, the remote operation system 112 may determine whether the remote operator is available or unavailable to receive and/or provide assistance to vehicles, as well as whether the remote operator is occupied or unoccupied to provide assistance.

At 510, the process 500 may include determining one or more preferences of the remote operator. In some examples, the one or more preference(s) may be determined based at least in part on the second data and/or the remote operation system 112 may access the preference(s) stored in association with the remote operator profile of the remote operator. As discussed herein, the preference(s) may be used to filter those requests of remote vehicles that are sent to the remote operator for assistance.

At 512, the process 500 may include receiving a request associated with providing assistance to the autonomous vehicle. For example, the remote operation system 112 may receive a request that the vehicle is in need of assistance, such as traversing about an environment, navigating a construction zone, and so forth.

At 514, the process 500 may include determining where a mission-type of the vehicle is acceptable. For example, the remote operation system 112 may determine a mission-type of the vehicle, and if the mission-type is not acceptable, or is a mission in which the remote operation system 112 does not provide assistance, the request may be ignored. The mission type may be determined, in some examples, via the first data and/or the request. The mission-types that may be unacceptable may be associated with training missions, or other testing-type missions in which the vehicle is being trained or otherwise tested. In this manner, the remote operation system 112 may understand the state of all the vehicles, but only a subset of these vehicles may be provided remote assistance. As such, those vehicles that are in service, transporting passengers, responding to passenger requests (e.g., ride sharing), and so forth may be considered suitable missions in which the remote operation system 112 provides assistance. If at 514 the process 500 determines that the mission type is not acceptable, the process 500 may follow the “NO” route and proceed to 516.

At 516, the process 500 may escalate the request. For example, if the mission-type not a suitable type of mission in which the remote operation system 112 provides assistance, the remote operation system 112 may determine to escalate the request for further review. This may include having the remote operators, or other observers, analyze the request to determine why no remote operators were matched to the request. In some examples, from there, the request may be ignored or disregarded to avoid having the request backlog the queue interface. In such examples, the request may be deleted (or removed) from the queue interface. In other examples, the request may be updated or otherwise modified such that the request is matched to one or more remote operators. Alternatively, if the mission type is acceptable, the process 500 may follow the “YES” route and proceed to 518.

At 518, the process 500 may include determining whether the status and/or the preference(s) match the request. For example, to provide assistance, the remote operator may need to be available (e.g., on-duty, not providing assistance to other vehicles, and so forth). In some examples, the preference(s) of the remote operator are compared to the data and/or the request to determine whether the preference(s) match the request. For example, knowing a location of the vehicle, the process 500 may determine whether the vehicle is within a geographical area serviced by the remote operator. Additionally, or alternatively, the type of assistance that the vehicle is requesting may be compared against the types of assistance that the first remote operator provides. In some examples, any number of preference(s) may be compared (e.g., experience, location of the remote operator, etc.) for determining whether the preference(s) match the request. In some examples, the preference(s) may have to match the request identically, or above a certain threshold, for determining whether the preference(s) match the request.

If at 518 the status and/or the preferences match the request, the process 500 may follow the “YES” route and proceed to 520. At 520, the process 500 may include sending an indication to a device of the remote operator associated with providing assistance to the autonomous vehicle. For example, the remote operation system 112 may send a request for the remote operator to accept the request to provide assistance to the autonomous vehicle. In some examples, the device of the remote operator may display an indication of the request, and/or present information associated with the vehicle.

If at 516, the process 500 determines that the status and/or the preference(s) do not match the request, the process 500 may follow the “NO” route and proceed to 522. At 522, the process 500 may include determining one or more additional remote operators to provide assistance to the autonomous vehicle. In some examples, these remote operators may be determined based on the status and/or the preference(s) of the remote operators. In some examples, if multiple remote operators are matched to the request, the remote operator that has provided the least assistance may be assigned to the request (e.g., to load balance). In other examples, the first remote operator to respond to the request may be assigned the request.

Although the process 500 is described as receiving a single request from a vehicle in need of assistance, the process 500 may be configured to handle any number of requests in parallel and assign the request to respect operators. As an example, a first request may be received from a first vehicle of a fleet of autonomous vehicles and a second request may be received from a second vehicle of the fleet.

### Example Clauses

The following paragraphs describe various examples. Any of the examples in this section may be used with any other of the examples in this section and/or any of the other examples or embodiments described herein.

A. A remote operations system for a fleet of autonomous vehicles, comprising: at least one processor; and at least one non-transitory memory having stored thereon processor-executable instructions that, when executed by the at least one processor, configure the remote operations system to: receive, from an autonomous vehicle, a request for remote operator assistance, the request including information indicative of one or more of: an event type, a mission type associated with the autonomous vehicle, sensor data associated with the autonomous vehicle, a location of the autonomous vehicle, a heading of the autonomous vehicle, or a speed of the autonomous vehicle; associate, based at least in part on the information, the request with a queue of remote operator requests; determine, among a plurality of remote operators, an availability of a remote operator; determine a status of the remote operator; determine criteria associated with the remote operator; determine, based at least in part on the information, the availability, the status, and the criteria, to send the request to the remote operator; and sending the request to a device of the remote operator to cause display of the request to the remote operator.

B. The remote operations system as recited in paragraph A, wherein the remote operator is a first remote operator, the availability is a first availability, and the status is a first status, the remote operations system being further configured to: determine, among the plurality of remote operators, a second availability of a second remote operator; determine a second status of the second remote operator; and determine, based at least in part on the second status, that the second remote operator is unavailable to provide the remote operator assistance, wherein sending the request to the first remote operator is further based at least in part on the second remote operator being unavailable.

C. The remote operations system as recited in any one of paragraphs A-B, the remote operations system being further configured to: receive, from the device, a response associated with accepting the request; and determine that the response was received within a threshold amount of time, wherein determining to send the remote operator the request is based at least in part on determining that the response was received within a threshold amount of time.

D. The remote operations system as recited in any one of paragraphs A-C, wherein: the status comprises one or more of: a designation of whether the remote operator is in training, a designation of whether the remote operator is on a break, or a designation of whether the remote operator is providing remote operator assistance to another vehicle; and the criteria comprises one or more of: a geographical area serviced by the remote operator, a mission type the remote operator is able to service, or a vehicle type the remote operator is able to service.

E. A method, comprising: receiving, from a vehicle, a request to provide remote operator assistance; associating the request with a queue; determining, among a set of available remote operators, a status of a remote operator to resolve the request; determining criteria associated with a remote operator; determining, based at least in part on the request, the status, and the criteria, to receive remote operator assistance from the remote operator; and sending information associated with the request to the remote operator.

F. The method as recited in paragraph E, wherein the request comprises information indicative of at least one of: a mission type of the vehicle, a speed of the vehicle, a location of the vehicle, or a heading of the vehicle.

G. The method as recited in any one of paragraphs E-F, wherein the mission type indicates at least one of: whether the vehicle is transporting a passenger, whether the vehicle is traveling to pick up an additional passengers, whether the vehicle is charging, or whether the vehicle is performing training; and wherein the status indicates whether the remote operator is occupied to receive requests for providing the remote operator assistance.

H. The method as recited in any one of paragraphs E-G, further comprising transmitting the remote operator assistance to the vehicle, wherein the vehicle is configured to be controlled based at least in part on the remote operator assistance.

I. The method as recited in any one of paragraphs E-H, wherein the criteria indicates at least one of: a geographical area in which the remote operator is knowledgeable for providing a response to the request, a vehicle type that the remote operator is knowledgeable for providing the response, a type of the remote operator assistance that the remote operator provides, or a mission type associated with autonomous vehicles.

J. The method as recited in any one of paragraphs E-I, further comprising: determining, for a plurality of remote operators, an availability of individual remote operators; determining, based at least in part on the availability of the individual remote operators, the set of available remote operators.

K. The method as recited in any one of paragraphs E-J, wherein the status comprises one or more of: a designation of whether the remote operator is in training, a designation of whether the remote operator is on a break, or a designation of whether the remote operator is providing remote operator assistance to another vehicle.

L. The method as recited in any one of paragraphs E-K, the method further comprising: determining that the remote operator accepted the request; and updating the status of the remote operator to indicate the remote operator is unavailable to receive additional requests while providing the remote operator assistance to the autonomous vehicle.

M. The method as recited in any one of paragraphs E-L, wherein the remote operator is a first remote operator, the status is a first status, the method further comprising: determining, among the set of available remote operators, a second status of a second remote operator to resolve the request; determining, based at least in part on the second status, that the second remote operator is occupied, wherein sending the request to the first remote operator is further based at least in part on the second remote operator being occupied.

N. The method as recited in any one of paragraphs E-M, wherein determining the remote operator comprises: filtering, using a first filter associated with a mission-type, the set of available remote operators to determine a first portion; and filtering, using a second filter associated with a geographical area, the first portion of the available remote operators to determine a second portion of the remote operators, wherein the remote operator is associated with the second portion.

O. One or more non-transitory computer-readable media storing instructions that, when executed by one or more processors, cause the one or more processors to perform actions comprising: receiving, from a vehicle, a request to provide remote operator assistance; associating the request with a queue; determining, among a set of available remote operators, a status of a remote operator to resolve the request; determining criteria associated with a remote operator; determining, based at least in part on the request, the status, and the criteria, to request the remote operator assistance from the remote operator; and sending information associated with the request to the remote operator.

P. The one or more non-transitory computer-readable media as recited in paragraph O, the actions further comprising: determining that the remote operator accepted the request; and updating the status of the remote operator to indicate the remote operator is unavailable to receive additional requests while providing the remote operator assistance to the autonomous vehicle.

Q. The one or more non-transitory computer-readable media as recited in any one of paragraphs O-P, the operations further comprising: receiving, from the remote operator, the remote operator assistance; and transmitting, to the vehicle, the remote operator assistance, wherein the vehicle is configured to be controlled based at least in part on the remote operator assistance.

R. The one or more non-transitory computer-readable media as recited in any one of paragraphs O-Q, wherein the status comprises one or more of: a designation of whether the remote operator is in training, a designation of whether the remote operator is on a break, or a designation of whether the remote operator is providing remote operator assistance to another vehicle.

S. The one or more non-transitory computer-readable media as recited in any one of paragraphs O-R, wherein the remote operator is a first remote operator, the status is a first status, the actions further comprising: determining, among the set of available remote operators, a second status of a second remote operator to resolve the request; determining, based at least in part on the second status, that the second remote operator is occupied, wherein sending the request to the first remote operator is further based at least in part on the second remote operator being occupied.

T. The one or more non-transitory computer-readable media as recited in any one of paragraphs O-S, wherein determining the remote operator comprises: filtering, using a first filter associated with a mission-type, the set of available remote operators to determine a first portion; and filtering, using a second filter associated with a geographical area, the first portion of the available remote operators to determine a second portion of the remote operators, wherein the remote operator is associated with the second portion.

While the example clauses described above are described with respect to one particular implementation, it should be understood that, in the context of this document, the content of the example clauses may also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A remote operations system for a fleet of autonomous vehicles, comprising:
at least one processor; and
at least one non-transitory memory having stored thereon processor-executable instructions that, when executed by the at least one processor, configure the remote operations system to:
receive, from an autonomous vehicle, a request for remote operator assistance, the request including information indicative of one or more of:
an event type,
a mission type associated with the autonomous vehicle,
sensor data associated with the autonomous vehicle,
a location of the autonomous vehicle,
a heading of the autonomous vehicle, or
a speed of the autonomous vehicle;
associate, based at least in part on the information, the request with a queue of remote operator requests;
determine, among a plurality of remote operators, an availability of a remote operator;
determine a status of the remote operator;
determine criteria associated with the remote operator;
determine, based at least in part on the information, the availability, the status, and the criteria, to send the request to the remote operator; and
sending the request to a device of the remote operator to cause display of the request to the remote operator.

2. The remote operations system of claim 1, wherein the remote operator is a first remote operator, the availability is a first availability, and the status is a first status, the remote operations system being further configured to:
determine, among the plurality of remote operators, a second availability of a second remote operator;
determine a second status of the second remote operator; and
determine, based at least in part on the second status, that the second remote operator is unavailable to provide the remote operator assistance,
wherein sending the request to the first remote operator is further based at least in part on the second remote operator being unavailable.

3. The remote operations system of claim 1, the remote operations system being further configured to:
receive, from the device, a response associated with accepting the request; and
determine that the response was received within a threshold amount of time,
wherein determining to send the remote operator the request is based at least in part on determining that the response was received within a threshold amount of time.

4. The remote operations system of claim 1, wherein:
the status comprises one or more of:
a designation of whether the remote operator is in training,
a designation of whether the remote operator is on a break, or
a designation of whether the remote operator is providing remote operator assistance to another vehicle; and
the criteria comprises one or more of:
a geographical area serviced by the remote operator,
a mission type the remote operator is able to service, or
a vehicle type the remote operator is able to service.

5. A method, comprising:
receiving, from a vehicle, a request to provide remote operator assistance;
associating the request with a queue;
determining, among a set of available remote operators, a status of a remote operator to resolve the request;
determining criteria associated with a remote operator;
determining, based at least in part on the request, the status, and the criteria, to receive remote operator assistance from the remote operator; and
sending information associated with the request to the remote operator.

6. The method of claim 5, wherein the request comprises information indicative of at least one of:
a mission type of the vehicle,
a speed of the vehicle,
a location of the vehicle, or
a heading of the vehicle.

7. The method of claim 6, wherein the mission type indicates at least one of:
whether the vehicle is transporting a passenger,
whether the vehicle is traveling to pick up an additional passengers,
whether the vehicle is charging, or
whether the vehicle is performing training; and
wherein the status indicates whether the remote operator is occupied to receive requests for providing the remote operator assistance.

8. The method of claim 5, further comprising transmitting the remote operator assistance to the vehicle,
wherein the vehicle is configured to be controlled based at least in part on the remote operator assistance.

9. The method of claim 5, wherein the criteria indicates at least one of:
a geographical area in which the remote operator is knowledgeable for providing a response to the request,
a vehicle type that the remote operator is knowledgeable for providing the response,
a type of the remote operator assistance that the remote operator provides, or
a mission type associated with autonomous vehicles.

10. The method of claim 9, further comprising:
determining, for a plurality of remote operators, an availability of individual remote operators;
determining, based at least in part on the availability of the individual remote operators, the set of available remote operators.

11. The method of claim 5, wherein the status comprises one or more of:
a designation of whether the remote operator is in training,
a designation of whether the remote operator is on a break, or
a designation of whether the remote operator is providing remote operator assistance to another vehicle.

12. The method of claim 5, the method further comprising:
determining that the remote operator accepted the request; and
updating the status of the remote operator to indicate the remote operator is unavailable to receive additional requests while providing the remote operator assistance to the autonomous vehicle.

13. The method of claim 5, wherein the remote operator is a first remote operator, the status is a first status, the method further comprising:
determining, among the set of available remote operators, a second status of a second remote operator to resolve the request;
determining, based at least in part on the second status, that the second remote operator is occupied,
wherein sending the request to the first remote operator is further based at least in part on the second remote operator being occupied.

14. The method of claim 5, wherein determining the remote operator comprises:
filtering, using a first filter associated with a mission-type, the set of available remote operators to determine a first portion; and
filtering, using a second filter associated with a geographical area, the first portion of the available remote operators to determine a second portion of the remote operators,
wherein the remote operator is associated with the second portion.

15. One or more non-transitory computer-readable media storing instructions that, when executed by one or more processors, cause the one or more processors to perform actions comprising:
receiving, from a vehicle, a request to provide remote operator assistance;
associating the request with a queue;
determining, among a set of available remote operators, a status of a remote operator to resolve the request;
determining criteria associated with a remote operator;
determining, based at least in part on the request, the status, and the criteria, to request the remote operator assistance from the remote operator; and
sending information associated with the request to the remote operator.

16. The one or more non-transitory computer-readable media of claim 15, the actions further comprising:
determining that the remote operator accepted the request; and
updating the status of the remote operator to indicate the remote operator is unavailable to receive additional requests while providing the remote operator assistance to the autonomous vehicle.

17. The one or more non-transitory computer-readable media of claim 15, the operations further comprising:
receiving, from the remote operator, the remote operator assistance; and
transmitting, to the vehicle, the remote operator assistance,
wherein the vehicle is configured to be controlled based at least in part on the remote operator assistance.

18. The one or more non-transitory computer-readable media of claim 15, wherein the status comprises one or more of:
a designation of whether the remote operator is in training,
a designation of whether the remote operator is on a break, or
a designation of whether the remote operator is providing remote operator assistance to another vehicle.

19. The one or more non-transitory computer-readable media of claim 15, wherein the remote operator is a first remote operator, the status is a first status, the actions further comprising:
determining, among the set of available remote operators, a second status of a second remote operator to resolve the request;
determining, based at least in part on the second status, that the second remote operator is occupied,
wherein sending the request to the first remote operator is further based at least in part on the second remote operator being occupied.

20. The one or more non-transitory computer-readable media of claim 19, wherein determining the remote operator comprises:
filtering, using a first filter associated with a mission-type, the set of available remote operators to determine a first portion; and
filtering, using a second filter associated with a geographical area, the first portion of the available remote operators to determine a second portion of the remote operators,
wherein the remote operator is associated with the second portion.
